(19) United States
(12) Patent Application Publication
(10) Pub. No.: US 2020/0219176 A1
(43) Pub. Date: Jul. 9, 2020

(54) ACCESSORY SELECTION AND RENDERING SYSTEM AND METHOD OF USE

(71) Applicant: Maria Ioana Marin, Uppsala (SE)

(72) Inventor: Maria Ioana Marin, Uppsala (SE)

(21) Appl. No.: 16/021,774

(22) Filed: Jun. 28, 2018

(51) Int. Cl. G06Q 30/06; G06F 3/0482; G06T 19/00

(52) U.S. Cl. CPC G06Q 30/0643; G06T 19/006; G06F 3/0482

(57) ABSTRACT

An accessory selection and rendering system enables a user to browse and select from a vast assortment of products that accentuate or stylize the appearance of the user and their clothing in a virtual fashion. The products are available through a portal that is able to capture an image or video of the user in real time and superimpose the product thereon.

### BACKGROUND

### 1. Field of the Invention

The present invention relates generally to commercial systems, and more specifically, to the process of locating and purchasing outfit accessory items.

### 2. Description of Related Art

Commercial systems are well known in the art and are effective means to provide products to consumers across an infinite spectrum of markets. For example, FIG. 1 depicts a conventional item location system 101 having a vendor 103 with an inventory of products 105 where a person 107 visit either physically or digitally. The inventory of products 105 is evaluated, and items are purchased if desired. It is common for the person 107 to visit multiple vendors 103 in search of a desired product.

One of the problems commonly associated with system 101 is limited efficiency. For example, locating products related to the appearance of the person is difficult as the product must interact with other clothing items in some way. As a result, the clothing items or their color, patterns or the like must be available for comparison while looking for additional items. Additionally, the effort to locate and visit vendors is wasted if they do not have a desired product or item.

Accordingly, although great strides have been made in the area of item location systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common item location system;

FIG. 2 is a diagram of an accessory selection and rendering system in accordance with a preferred embodiment of the present application;

FIG. 3 is a front view of the computing device of FIG. 2;

FIG. 4 is a screen view of the portal of FIG. 2 in use;

FIG. 5 is an alternative rendering of a screen view of the portal of FIG. 2 in use;

FIG. 6 is an alternative rendering of a screen view of the portal of FIG. 2 in use;

FIG. 7 is an alternative rendering of a screen view of the portal of FIG. 2 in use;

FIG. 8 is an alternative rendering of a screen view of the portal of FIG. 2 in use; and

FIG. 9 is a flowchart of the preferred method of use of the system of FIG. 2.

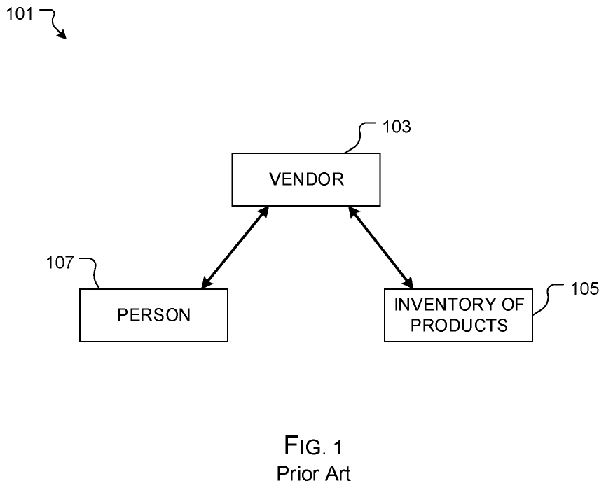

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional item location systems. Specifically, the invention of the present application enables a person to efficiently locate and evaluate potential purchases. In addition, the items or products are available for viewing so long as the person is able to access a network, such as from their home. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

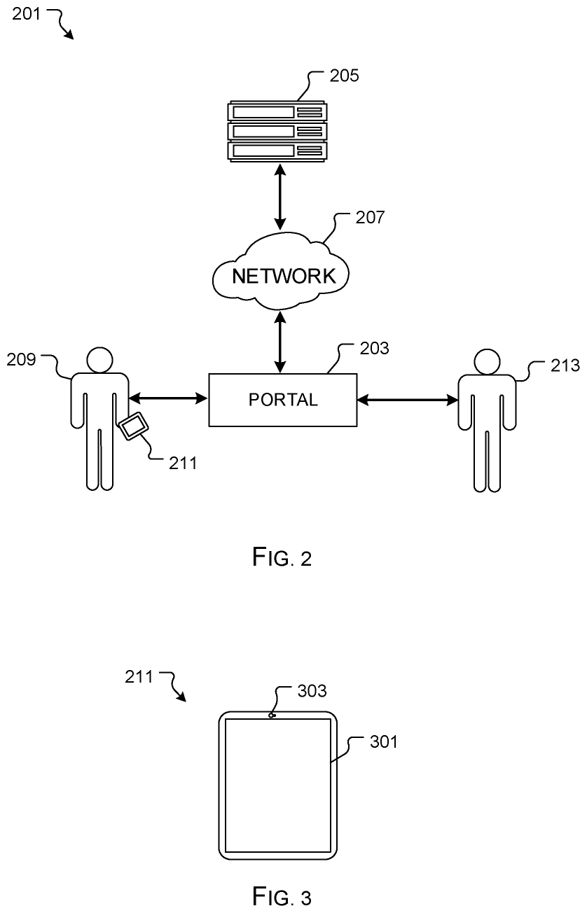

Referring now to the drawings wherein like reference characters identify corresponding or similar elements throughout the several views, FIG. 2 depicts a diagram of an accessory selection and rendering system in accordance with a preferred embodiment of the present application. It will be appreciated that system 201 overcomes one or more of the above-listed problems commonly associated with conventional item location systems.

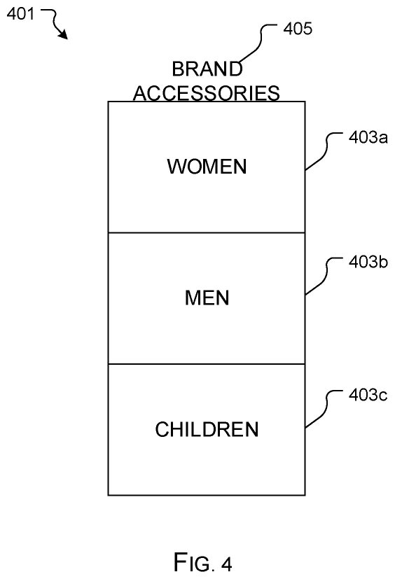

In the contemplated embodiment, system 201 includes a portal 203 in electronic communication with a database 205 via a network 207. The database 205 containing information related to products (e.g. accessories) offered for purchase by vendors 213. A user 209 access the portal 203 via a computing device 211 such as a CPU, smart phone or the like. The computing device having a display screen 301 and an image capture device 303 such a camera as depicted by FIG. 3.

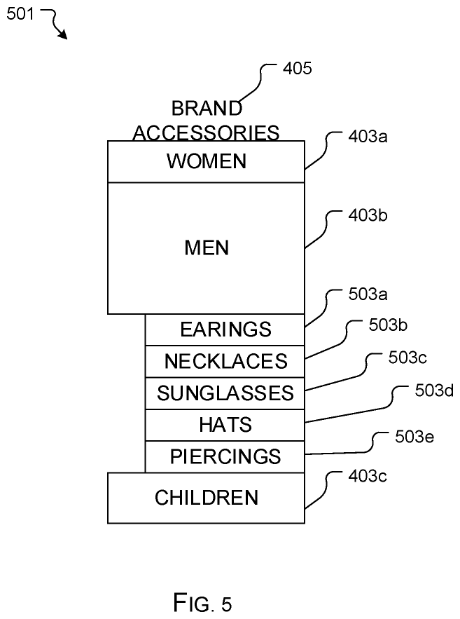

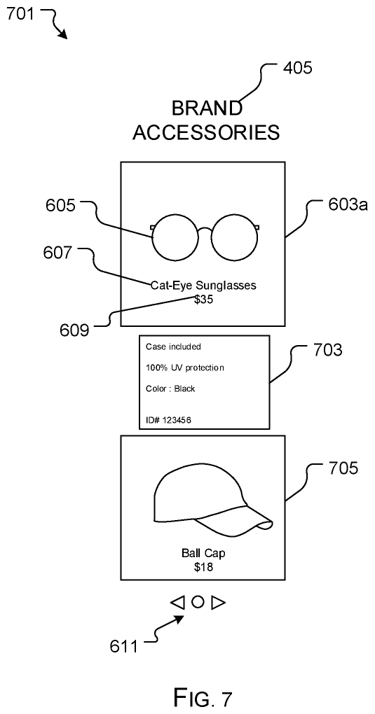

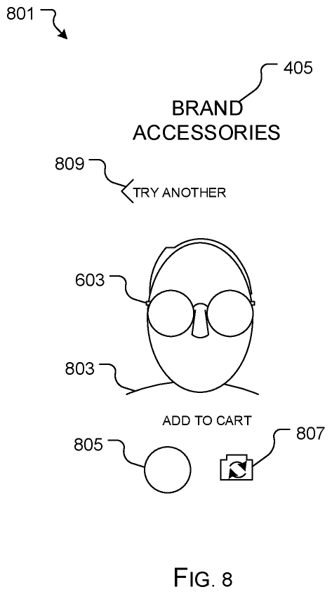

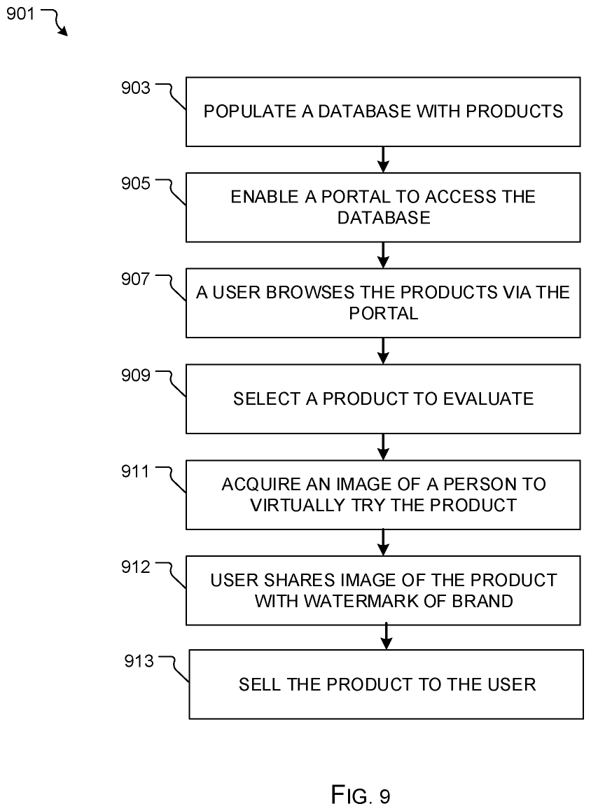

The portal 203 being configured to display the available products on the computing device 211. View of the portal in use are as depicted by FIGS. 4, 5 and 6, the user 209 access the portal 203 and selects an accessory class 403 or grouping. While women 403a, men 403b and children 403c are depicted it is contemplated that any class 403 could be used and that these are given as examples. The portal 203 includes a portal identifier 405.

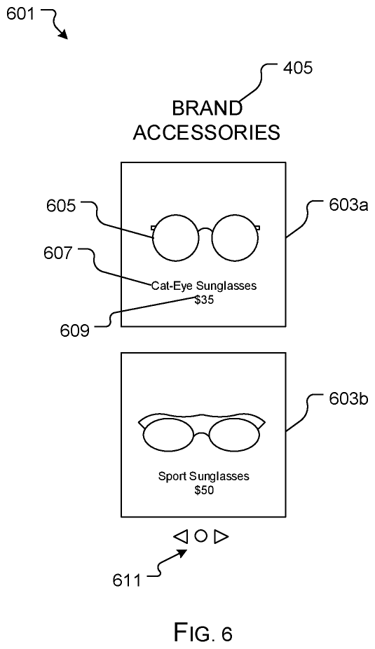

When a class 403 is selected the portal 203 returns categories 503 within that class 403. It will be understood that a category 503 could be within multiple classes 403. While FIG. 5 depicts examples of categories 503 it is contemplated that any category 503 could be used and that these are depicted only as examples.

When a category 503 is selected the portal 203 returns a listing 601 of available products 603 in the category 503. An image 605 of each product 603 is displayed with a title 607 and a price 609. Listing 601 is provided as an example format and any method of conveying the available products 603 to the user 209 is contemplated. The portal 203 includes functions 611 to navigate the listing 601.

The portal 203 provides additional information 701 when a product 603 is selected. This information 701 includes specifications 703 and related products 705 that the portal 203 or vendor 213 identify as compatible. It will be understood that the criteria of what is compatible are subjective and fluid.

A user 209 is able to virtually try on 801 the product 603 via the portal 203. The portal accesses the camera 303 of the device 211 and captures an image 803 or set of images of the user 209 and imposes the image 605 of the product 603 on that of the user. The portal 203 further includes the function of changing 809 products 603 capturing 805 a composite image of the product 603 and user 209 or otherwise controlling 807 the camera. It should be understood and appreciated that the system allows for the user to capture images or sets of images of themselves, as well as others, with the product on or being used therewith.

It should be appreciated that one of the unique features believed characteristic of the present application is that many products are available to be viewed and evaluated in a single place. It will be further appreciated that the user is able to quickly compare the products with other accessories with which they would like to coordinate.

Referring now to FIG. 9 the preferred method of use of the system 201 is depicted. Method 901 including populating a database with products 903, enabling a portal to access the database of products 905, a user browsing the products via the portal 907, selecting a product to evaluate 909, acquiring an image of the user or another person to virtually try the product 911, and share the image 912 and/or selling the product to the user 913. In the preferred embodiment, it is contemplated that after the user captures an image with the product, the user can share the image via social media, wherein the image can include a watermark/insignia of the brand of the vendor, thereby providing a means for the vendor to advertise via social platforms.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. An accessory selection and rendering system comprising:
a portal in electronic communication with at least one database of products; and
a user in communication with the portal via a computing device and a network;
wherein the products are accessories; and
wherein the portal is configured to enable the user to be virtually fitted with the product.

2. A method of facilitating the trying of accessories given the system of claim 1, comprising:
populating a database with products;
enabling a portal to access the database of products;
a user browsing the products via the portal;
selecting a product to evaluate;
acquiring an image of the user or another person to virtually try the product; and
selling the product to the user.
